(19) United States
(12) Patent Application Publication
(10) Pub. No.: US 2007/0199216 A1
(43) Pub. Date: Aug. 30, 2007

(54) Gear alignment and slip assembly for drive transmission system of multi-faced signs and billboards

(76) Inventor: Michael R. Atkinson, Jonesboro, AK (US)

Correspondence Address: CRUTSINGER & BOOTH, 1601 ELM STREET, SUITE 1950, DALLAS, TX, 752014744, US

(21) Appl. No.: 11/363,314

(22) Filed: Feb. 27, 2006

(51) Int. Cl. G09F 11/02

(52) U.S. Cl. 40/503; 40/624

(57) ABSTRACT

A sign (10) includes a gear subassembly (50, 52) and a slip assembly (74, 80) operatively associated between the drive shaft (42) and the output shaft (46) of one of the display elements (14). During a portion of a rotation of the input gear element (50), the input gear teeth (72) engage the output gear teeth (78). During another portion, the input gear teeth (72) disengage. At least one partial gear tooth (82a, 82b) assists in periodically aligning the gear teeth. The slip subassembly comprises: an input slip element (74) defining a generally arcuate line about the axis of the input slip element; and an output slip element (80) defining a generally straight line that is non-intersecting with and extends perpendicular to the input slip axis. During a portion of a rotation of the input slip element (74), the arcuate line and the straight line of the slip elements (74, 80) are in slipping contact to prevent the output slip element (80) from rotating. During another portion of the rotation, the output slip (80) can be rotated. The slip subassembly has a radius at least a large as the radius of the gear teeth (72, 78).

### CROSS REFERENCE TO RELATED APPLICATIONS

This application claims the priority of PCT patent application Serial No. PCT/US04/28898, filed Sep. 5, 2003, which claimed the priority of U.S. patent application Ser. No. 60/500,411, filed Sep. 5, 2003, now abandoned.

### TECHNICAL FIELD

The present invention relates to mechanical advertising displays, and more particularly, to signs and billboards that use multi-faced louvers to enable multiple sign displays, usually three, to be periodically or selectively shown on a single structure.

### BACKGROUND

Advertising signs are a widely used means of passing on advertising messages to the general public. Of particular success are sign displays that use a plurality of sign elements in the general shape of triangular prisms to enable three billboard type displays to be periodically or sequentially shown on a single structure.

The triangular prism segments, referred to in the art by various names such as “display elements” or “louvers”, are adapted for rotation about parallel axes, whereby predetermined ones of the plurality of faces of each display element can be aligned in co-planar relationship to produce a substantially complete image. By this means, for example, three different signs can be displayed by rotation of the triangular display elements and alignment of the display surfaces. In addition, the rotation of the display elements helps attract attention to the sign or billboard.

Typical mechanical signs, however, have experienced many problems. For example, the synchronization of the louvers must be maintained, or the displays will be disrupted. The mechanical interlocking of the louvers has posed reliability and maintenance difficulties and high costs. When the signs are used outdoors, weathering conditions also become a major factor in the reliability and maintenance. The larger the size of the sign magnifies these problems. Over the years, many designs have been tried to improve the reliability and reduce maintenance costs associated with this kind of sign, however, problems with reliability and maintenance have continued to plague the industry.

U.S. Pat. No. 1,461,047 entitled “Advertising Sign” filed May 25, 1920 having for named inventor Joseph L. Ray discloses an advertising sign having a permanent frame indicated at a, supported on suitable standards b. In the supporting standards b for the frame, or in any other desired relation thereto, is supported a rotatable shaft d on which may be keyed a series of gear wheels e on each of which is bolted a gear segment f. The segment f may be carried by a bolt f adapted to be moved adjustably in a segmental slot e′ cut in each of the wheels e. The shaft d is geared operatively to a prime mover g by which rotation is imparted to each of the gear wheels e.

U.S. Pat. No. 3,307,170 entitled “Multi-Face Indicator System” issued Feb. 28, 1967 having for named inventors Tetsuo Aoyama, et al. discloses a multi-face indicator having a number of indicating faces of different color, any one of which may be moved selectively to one indicating position. With each indicator having more than one indicating face, each of a different color, the different faces can be combined with other such indicators to form a numeral, letter, symbol or other pattern. But the highly complex inter-workings to regulate the turning of particular triangle portions of each indicator and the many moving parts increased the possibility of breakdown and the difficulty of repair.

U.S. Pat. No. 3,387,394 entitled “Sign Construction” issued Jun. 11, 1968 having for named inventor Willy T. Werner discloses a display sign of the type in which three different advertising messages are presented in sequence by rotation of a plurality of three-sided louvers. Panels are secured to core members to make up the louvers by means of brackets and clips which secure these members together upon relative movement in one direction. A lock between the core members and panels prevents movement in a direction permitting disengagement. A spring biased pin carried by the louvers snaps into engagement with a frame to rotatably support the upper end of the louvers.

U.S. Pat. No. 4,021,946 entitled “Multielement Changeable Sign Display” issued May 10, 1977 having for named inventor James T. Bradshaw discloses a sign display comprising a plurality of triangular display elements each having three display surfaces. The display elements are arranged along mutually perpendicular sets of axes to define a matrix display having a display pane. Rotary drive shafts extend through the display elements parallel to the display surfaces, and each display element includes a clutch structure comprising frustoconical clutch members received in frustoconical apertures formed in the display element and spring biased to be normally coupled to the display element for rotation with the drive shaft extending therethrough. Abutment surfaces corresponding to the display surfaces project from the lower end of each display element for selective actuation to terminate rotation of the display element with a predetermined display surface situated in the display pane. The first display surfaces of all of the display elements may be utilized in combination to form a dedicated sign, and the second and third display surfaces of each display element may comprise contrasting colors, in which case the second and third surfaces of the display elements are utilized to form a desired sign by means of a matrix display.

U.S. Pat. No. 4,189,859 entitled “Device at Display Arrangement” issued Feb. 26, 1980 having for named inventor Stig B. Ahlgren discloses a display having a frame and prisms rotatably mounted therein, each of the prisms including adjacent longitudinally extending side surfaces so that each set of associated side surfaces of the prisms provides a display when rotated to a side-by-side position defining a permanently recurring sequence with the number of displays corresponding to the number of side surfaces on each prism. Each prism is provided with a pair of rotation axles disposed at opposite ends thereof. A drive motor and a transmission rotate the prisms synchronously, the drive motor being connected to one of the rotation axles. Gear discs are mounted on one rotation axle of each pair provided on the prisms with at least one belt mounted on the gear discs for rotating the gear discs and the prisms when one rotation axle is output by the drive motor, the belt being toothed for meshing with the gear disks. U.S. Pat. No. 4,189,589 is incorporated herein by reference in its entirety.

U.S. Pat. No. 4,638,580 entitled “Publicity Board with Rotating Prismatic Members,” issued Jan. 27, 1987 having named inventors Anna Giannetti, Sergio Massa, and Cesare Re that discloses a publicity board provided with a plurality of rotatable prismatic members mounted side-by-side, each being arranged to carry portions of publicity images on its faces, and further provided with a meter for rotating the prismatic members about their respective longitudinal axes. The motor is coupled to the prismatic members by means of an operating shaft driven by the motor and carrying a plurality of radial rods such that they rotate, to each cooperate with respective appendices extending radially from an end pivot of each prismatic member, for the purpose of transmitting to this latter a rotation through an angle which is double the angle formed at the center by each face of said prismatic member.

U.S. Pat. No. 5,161,421 entitled “Driving device for driving or operating elongate display members at signs for consecutive, repeated presentation of series of images” issued Nov. 10, 1992 having named inventor Stig E. A. Stigsson that discloses a driving device for driving or operating elongate display members at signs for consecutive, repeated presentation of series of images, whereby said elongate display members (2) are driven through pairs of gear wheels (15, 16) having conical teeth and whereby a driving gear wheel (15) in each pair of gear wheels is provided on a drive shaft (6) and a driven gear (16) wheel in each pair is operatively connected with the elongate display member (2) to be driven. In this driving device, for being able to rotate the driving unit forming part thereof continuously in one and same direction of rotation and to ensure that the elongate display members can not come “out of phase” neither during rotation nor when they stand still in their display positions, the driving gear wheel (15) comprises a gear sector (20) which occupies only a part of the periphery of said driving gear wheel (15) such that said driving gear wheel (15), is in driving engagement with the driven gear wheel (16) only during a part of a revolution of said driving gear wheel (15) and the drive shaft (6) has a lock (21) which is provided to cooperate with said driven gear wheel (16) or with members non-rotatably connected therewith in such a manner that said driven gear wheel (16) is blocked against rotation during that part of the revolution of said driving gear wheel (15) when the gear sector (20) of said driving gear wheel (15) is out of driving engagement with the teeth (18) of said driven gear wheel (16).

U.S. Pat. No. 5,255,463 entitled “Rotating Sign Assembly” issued Oct. 26, 1993 having for named inventor Paul H. Werner discloses a rotating sign assembly including a number of multi-sided, rotatable sign segments output by an elongated drive shaft operably interconnected with each of the sign segments. The drive shaft includes at least one multi-armed output cam fitted to the drive shaft. Each arm of the output cam includes an outer sloped driving surface and a peaked extremity. The output cam is rotatably output by a driving arm assembly comprising a driving pin plate and an output arm stop plate. The driving pin plate includes a pair of pins, one situated on each end of the plate. Each driving pin alternatingly interacts with the outer sloped surfaces of the cam for rotation thereof, this rotation being halted by interaction of the peaked extremities alternatingly with the ends of the stop plate.

U.S. Pat. No. 5,255,465 entitled “Multiple Display Sign Assembly” issued Oct. 26, 1993 having for named inventor Hector Perez discloses a multi-display sign assembly including a frame structure having a pair of support bars, and a plurality of elongated, lightweight triangular members rotatably held between the support bars by axle bars which extend longitudinally through the triangular members and protrude through the support bars. A motor is connected to a reducer which regulates the RPM's of a drive gear connected thereto, the drive gear including teeth only along 120 degrees of its exterior surface such that, when the teeth engage a secondary gear which is connected to the axle bar of one of the triangle members, that triangle member will rotate resulting in a new display face of all the triangle members rotating to form a new one of three distinct display surfaces containing advertising or like indicia thereon. U.S. Pat. No. 5,255,465 is incorporated herein by reference in its entirety.

U.S. Pat. No. 5,511,330 entitled “Louver Sign Transmission System” issued Apr. 30, 1996 having for named inventor Dale I. Havens discloses a transmission system for louver type signs wherein the signs consist of a plurality of multiple faced louvers having indicia defined thereon, and the side-by-side relationship of the louvers permits pre-selected faces to define a completed image and simultaneous partial rotation of the louvers presents a new visible image, and wherein each louver is operated by a separate “T” drive bevel gear transmission having an output shaft upon which a louver is mounted operatively connected to a drive shaft perpendicularly related to the output shaft. The drive shafts of adjacent transmissions are interconnected, and a plurality of transmissions are simultaneously operated by a single motor drive source. U.S. Pat. No. 5,511,330 is incorporated herein by reference in its entirety.

U.S. Pat. No. 5,806,221 entitled “Drive For A Multi-Sided Display Sign” issued Sep. 15, 1998 having for named inventor Loren L. Vander Woude discloses a segmented sign drive that provides rotational driving force from a drive arm moving in reciprocating motion. The arm moves a series of pins in a series of grooves located in drive disks. A drive disk is mounted to each segment of the sign so as to rotate the segments into preferred positions in a step-by-step sequence where all of the segments move together to new positions so as to change the outward appearance of the sign. The grooves are ramped so that, on a forward stroke of the drive arm, the pins are moved upward on a ramped groove in the drive disks to fall into a preferred hole at one end of each of the grooves. On the return or reverse stroke, the pins, now caught within the holes, cause the disks to rotate by one part of the cycle. On the next cycle, the pins again move out of the holes and up the ramp surfaces of the next grooves which have been moved into place where the former grooves were. In this manner, the disks are caused to rotate by an appropriate amount on each rotational cycle of a switch limited motor. U.S. Pat. No. 5,806,221 is incorporated herein by reference in its entirety.

U.S. Pat. No. 6,038,799 entitled “Indexing System For Changeable Signs” issued Mar. 21, 2003 having for named inventors Dale I. Havens and Michael R. Atkinson discloses an indexing system for signs consisting of a plurality of indicia bearing vane faces wherein the vane faces are sequentially exposed to view in the manner of a “wave”, such sequential revealing of the sign vane faces generating interest in the sign's message. Each sign vane is rotated by a transmission, and the transmissions are interconnected in such a manner as to sequentially operate the vanes to produce the “wave” action and detents associated with each transmission lock the sign vane in the desired position. U.S. Pat. No. 6,038,799 is incorporated herein by reference in its entirety.

U.S. Pat. No. 6,065,232 entitled “Multiple Display System” issued May 23, 2000 having for named inventors Charles S. Haughey et al. discloses an apparatus for controlling a drive mechanism of a panel display system that includes a rotary member attached to a drive assembly, the rotary member having indicators located at known intervals that are detected to ensure that the drive assembly starts and stops at precise locations. In a preferred embodiment, the control system is applied to a panel display system that displays different scenes using an array of elongated three-sided display elements. The preferred control system includes an aluminum disk that is attached to rotate in connection with rotation of the drive assembly.

U.S. Pat. No. 6,128,841 entitled “Drive Mechanism for Picturn Sign” issued Oct. 10, 2000 having for named inventor Paul H. Werner discloses a rotating sign assembly having a plurality of rotatable, multi-sided, sign segments and a drive mechanism for rotatably driving the sign segments. The drive mechanism includes a drive shaft and one or more output shafts that each operate to rotate a multi-sided sign segment. A cam is fitted to each of the output shafts so that rotation of the cam causes rotation of the corresponding output shaft and sign segment. The cam has an outer perimeter and multiple equally spaced engagement slots which extend radially inwardly from the outer perimeter. Outwardly facing stabilizing portions are positioned between each of the engagement slots. The cam has multiple dwell positions, each corresponding to the display of one side of the multi-sided sign segment operated by the corresponding output shaft. A cam driver assembly is fitted to the drive shaft so that it rotates with the drive shaft. The cam driver assembly has a cam driver which extends outwardly from the axis of rotation and terminates in a knob. The knob describes an arc as the cam driver is rotated about the axis of rotation. The cam driver is configured to engage one of the engagement slots when the cam is in a dwell position and to rotate the cam to another dwell position as the cam driver assembly is rotated about its axis of rotation. The cam driver assembly also includes a stabilizing member which is configured to engage one of the stabilizing portions of the cam when the cam is in a dwell position.

U.S. Pat. No. 6,295,882 entitled “Device for Operating Display Members at Signs” issued Oct. 2, 2001 having for named inventor Jonas O. Osterberg discloses a device for operating display members at signs for consecutive, repeated presentation of series of images, wherein the members are operated by a driving gear wheel on a drive shaft through a driven gear wheel for each member. The drive shaft has a lock cooperating with a member being non-rotatably connected with the driven gear wheel for setting in a locking position for blocking the driven gear wheel against rotation when no engagement between the gear wheels is present, and leaving its locking position for permitting rotation of the driven gear wheel before engagement once again is present. The lock comprises a first lock member which in locking position cooperates with one of the side surfaces on the non-rotatable member for blocking the driven gear wheel against rotation and preventing displacement of the gear wheels relative to each other in one direction along the longitudinal direction of the drive shaft, and at least one second lock member for at least preventing displacement of the gear wheels relative to each other in at lest the opposite direction along the longitudinal direction of the drive shaft.

As can be seen from the range of different efforts disclosed in these patents of the prior art, there has been a long-felt need for improved drive and gear systems for multi-faced signs. While each of these prior art patents expands the prior art, and may provide certain advantages and benefits, the number of recent patents demonstrates the continued long-felt need for a reliable and cost-effective solution to the maintenance issues associated with the drive and gear systems for multi-faced signs. While several of the prior patents, including U.S. Pat. Nos. 5,161,421; 6,128,841; and 6,295,882 describe certain useful design elements, the prior art still does not adequately solve the problem. For example, while the knobbed cam driver disclosed in U.S. Pat. No. 6,128,841 is interesting, it is not equivalent to the efficiency and reliability of a geared system.

### SUMMARY OF THE INVENTION

The present invention is for use in a multi-faced sign assembly. The sign typically comprises but unless specifically claimed does require: (A) a frame; (B) a drive shaft rotationally supported by the frame, where the drive shaft defines a drive shaft rotational axis; (C) a drive motor operatively connected to rotationally drive the drive shaft; (D) a plurality of display elements supported by the frame in a row, where each of the display elements: (i) defines a plurality of display faces; and (ii) is rotationally supported adjacent another one of the display elements; where the plurality of display elements can be selectively rotated to align one display face of each of the display elements in a co-planar relationship to form a substantially planar display, whereby the plurality of display elements can selectively display one of a plurality of displays; and (E) an output shaft operatively associated with each of the display elements, where the output shaft of each of the display elements: (i) is operatively connected to rotate an associated one of the plurality of display elements; (ii) defines an output shaft rotational axis; and (iii) has its output shaft rotational axis in non-parallel relationship to the rotational axis of the drive shaft.

The sign includes a gear subassembly operatively associated between the drive shaft and the output shaft of one of the display elements. The gear subassembly comprises: (i) an input gear element: (a) operatively connected to be rotated by the drive shaft; (b) defining an input gear element rotational axis; and (c) comprising a plurality of input gear teeth arranged to extend in a first arcuate portion around the input gear element rotational axis and defining a gap in the plurality of input gear teeth that extends in a second arcuate portion around the input gear element rotational axis; and (ii) an output gear element: (a) operatively connected to the output shaft; (b) defining an output gear element rotational axis; and (c) comprising a plurality of output gear teeth arranged to extend circumferentially around the output gear element rotational axis, the output gear teeth adapted to mesh with the input gear teeth of the input gear element; where: (i) during a first portion of a 360 degree rotation of the input gear element, the input gear teeth engage the output gear teeth to transfer rotational motion from the drive shaft to the output shaft; and (ii) during a second portion of a 360 degree rotation of the input gear element, the input gear teeth disengage the output gear teeth to not transfer rotational motion from the drive shaft to the output shaft.

According to a first aspect of the invention, the sign comprises at least one alignment element for the gear subassembly, where the alignment element: (i) is operatively positioned adjacent an arcuate end of the plurality of input gear teeth; and (ii) comprises a partial gear tooth.

According to a second aspect of the invention, the sign includes a slip subassembly operatively associated between the drive shaft and the output shaft. The slip subassembly comprises: (i) an input slip element: (a) operatively connected to be rotated by the drive shaft; (b) defining an input slip rotational axis; (c) defining a generally arcuate line that has a radius from the input slip rotational axis at least as large as the radius of the plurality of input gear teeth, that is non-intersecting with the input slip rotational axis, and that extends around a first portion of the input slip rotational axis, and (d) defining a generally arcuate gap along an arcuate line that has a radius from the input slip rotational axis at least as large as the radius of the plurality of input gear teeth, and that extends around a second portion of the input slip rotational axis; and (ii) an output slip element: (a) operatively connected to the output shaft; (b) defining an output slip rotational axis; and (c) defining a generally straight line that has a radial distance from the rotational axis of the output slip hub at least as large as the radius of the plurality of output gear teeth, that is non-intersecting with the input slip rotational axis, and that extends perpendicular to the input rotational axis of the input slip, the straight line adapted to be rotationally positioned into substantially co-planar alignment with the generally arcuate line defined by the input slip element. During a first portion of a 360 degree axial rotation of the input slip element, the arcuate line defined by the input slip element and the straight line defined by the output slip element are in substantially co-planar alignment, and the input and output slip elements are in slipping contact as the input slip element rotates to prevent the output slip element from rotating. During a second portion of a 360 degree rotation of the input slip element, the arcuate line defined by the input slip element and the straight line defined by the output slip element are out of co-planar alignment as the input slip element rotates, and the elements are out of slipping contact to allow the output slip element to rotate. It is believed that the large radius of the slip subassembly provides mechanical advantage and is stronger and more durable.

According to a third and important aspect of the invention, the first and second aspects of the invention are most advantageously employed together.

These and other aspects and advantages of the invention will become apparent to persons skilled in the art from the following drawings and detailed description of presently most-preferred embodiments of the invention.

### BRIEF DESCRIPTION OF THE DRAWING

The accompanying views of the drawing are incorporated into and form a part of the specification to illustrate several aspects and examples of the present invention, wherein like reference numbers refer to like parts throughout the figures of the drawing. These figures together with the description serve to explain the general principles of the invention. The figures are only for the purpose of illustrating preferred and alternative examples of how the various aspects of the invention can be made and used and are not to be construed as limiting the invention to only the illustrated and described examples. The various advantages and features of the various aspects of the present invention will be apparent from a consideration of the drawings.

FIG. 1 is a perspective view of a multi-faced billboard sign in a typical vertical orientation to the ground, the sign having a frame, a plurality of multi-faced display elements rotationally supported in the frame, a drive motor, and a drive transmission system for periodically rotating the display elements.

FIG. 2 is an exploded perspective of an example of the major parts of one type of a prismatic display element having three planar display surfaces, which is rotationally supported by a lower end cap and an upper bushing.

FIG. 3 is an exploded perspective of an example of the major parts of another type of a prismatic display element having three mounting structures adapted for receiving and supporting changeable display panels (not shown in FIG. 3), which is rotationally supported by a lower end cap and an upper bushing.

FIG. 4 is a perspective view illustrating a changeable face panel being mounted to or removed from the prismatic body of the type of display element shown in FIG. 3.

FIG. 5 is a front elevation view of the drive motor and part of the drive transmission system for a multi-faced billboard sign.

FIG. 6 is a perspective view of the drive motor and the drive transmission system for a multi-faced billboard sign having a plurality of gear subassemblies and locking subassemblies according to the invention, wherein the drive transmission system rotates the prismatic display elements in a wave-like manner.

FIG. 6A is an enlarged perspective view of the drive-motor end of the transmission system shown in FIG. 6.

FIG. 6B is an enlarged perspective view of the terminal end of the transmission system shown in FIG. 6.

FIG. 7A is a perspective view of the integrally-formed gear alignment and slip structures according to the presently most-preferred embodiment of the invention, where the input gear teeth are rotating into engagement with the output gear teeth.

FIG. 7B is a perspective view of the integrally-formed gear alignment and slip structures according to the presently most-preferred embodiment of the invention, where the input gear teeth are engaged with the output gear teeth to rotate the output gear element.

FIG. 7C is a perspective view of the integrally-formed gear alignment and slip structures according to the presently most-preferred embodiment of the invention, where (i) the input gear teeth are rotating out of engagement with the output gear teeth, and (ii) an arcuate surface of the input slip flange of the input slip element and a slip face of the output slip flange are rotated into slipping engagement that prevents the rotation of the output shaft.

FIG. 7D is a perspective view of the integrally-formed gear alignment and slip structures according to the presently most-preferred embodiment of the invention, where (i) the input gear teeth are rotating out of engagement with the output gear teeth, and (ii) an arcuate surface of the input slip flange of the input slip element and a slip face of the output slip flange are rotated into slipping engagement that prevents the rotation of the output shaft.

FIG. 8 is a perspective view of an alternative embodiment according to the present invention, where a single, integrally-formed gear subassembly with alignment teeth and slip subassembly are used to index a drive transmission system for a multi-faced sign.

### DETAILED DESCRIPTION OF THE PRESENTLY MOST PREFERRED EMBODIMENT AND BEST MODE

As used herein, the word “billboard” refers to a large sign, typically a large format sign for outdoors. The preferred embodiments of various aspects of this invention are particularly adapted to be able to be used in “large format” outdoor billboard displays. For example, our present expectation is that this design will work well in a large format sign up to a typical size used in the United States of fourteen (14) feet tall and forty-eight (48) feet long, and preferably in a sign substantially larger than that.

It is to be understood that, unless expressly noted, relational terms such as “vertical”, “horizontal”, “bottom”, “top”, “lower”, “upper”, “front”, “back”, “side”, “left”, “right”, “clockwise”, “counter-clockwise”, etc. are arbitrarily assigned for convenient reference to the orientation and perspective of the figures of the drawing. Furthermore, it is to be understood that relative terms such as “length”, “width”, “height”, etc. are also arbitrarily assigned for convenient reference to the orientation and perspective of the figures of the drawing. For the sake of consistency of usage, once a term is first arbitrarily assigned for reference to a structure in a particular figure, the term will then be used consistently to refer to like parts throughout the other figures of the drawing, even if the orientation of a structure shown in another figure is different for the purpose of showing another feature of the preferred embodiment(s) of the invention. It is to be understood that, unless the context otherwise requires, the use of such arbitrarily-assigned relational or relative terms is not to be construed as unnecessarily limiting the invention.

As used herein and in the claims, the words “comprises” and “includes” are each intended to have an open, non-limiting meaning that does not exclude additional elements or parts of an assembly, subassembly, or structural element.

Unless otherwise expressly stated, the words used in this disclosure and the claims are intended to have their broadest ordinary meaning to persons of skill in the art. First and foremost, the possible definitions of the words used herein are intended to be interpreted by reference to comprehensive general dictionaries of the English language published before or about the time of the filing of the application for patent. Where multiple ordinary definitions are available, the definitions or senses are intended to be selected according to the broadest sense or senses that are not inconsistent with the description of the presently most-preferred embodiments of the invention, including without limitation as shown in the drawings herein. After consulting such general dictionaries, it is intended that the words be further defined or the most appropriate definition or definitions be selected by consulting engineering dictionaries, encyclopedias, treatises, and relevant prior art to which this invention pertains. It is intended that, by examining relevant dictionaries, encyclopedias, treatises, and prior art to ascertain possible meanings that can be attributed to the words of the description and claims by those skilled in the art, and by further utilizing the record to select from those possible meanings, the definition or definitions not inconsistent with the use of the words herein, the intended full breadth of the words and terms will be more accurately determined and the improper importation of unintended limitations from the written description into the claims will be more easily avoided.

It should also be understood that the function of a single structure described herein can sometimes be performed by more than one part, or the functions of two different structures can be performed by a single or integrally-formed part. Especially from a manufacturing perspective, it is highly preferred to design the storage device to minimize the total number of parts required to manufacture the storage device. It is not only the costs associated with making additional parts, but also the costs of assembly. Preferably, the fewest possible number of steps and manipulations required to assemble the apparatus, the better.

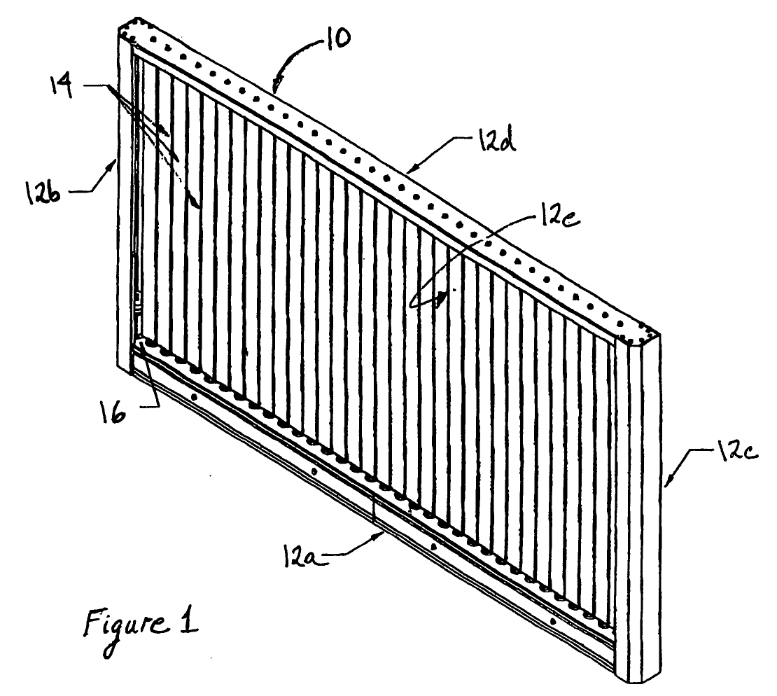

Referring now to the drawing, FIG. 1 is a perspective view of a multi-faced billboard sign 10. The sign 10 has a frame 12, preferably including a bottom 12a, sides 12b and 12c, and top 12d. The frame 12 defines a window 12e in the front of the sign. A plurality of display elements 14 are supported by the frame 12 in a row, where each of the display elements 14: (i) defines a plurality of display faces (only one of which is shown in FIG. 1); and (ii) is rotationally supported adjacent another one of the display elements; where the plurality of display elements can be selectively rotated to align one display face of each of the display elements in a co-planar relationship to form a substantially planar display, whereby the plurality of display elements can selectively display one of a plurality of displays (not illustrated) in the window 12e. The sign 10 is shown with the display elements 14 in a typical vertical orientation to the ground, but it is to be understood that the display elements could be horizontally or otherwise oriented as desired.

The sign 10 includes a drive motor 16 supported by the frame 12. As will hereinafter be described and illustrated in detail, a drive transmission system (not visible in FIG. 1) for periodically rotating the display elements 14 is enclosed in the frame 12, preferably in the bottom 12a of the frame 12.

Preferably each of the display elements 14 is a generally triangular prism with three display faces. Each of the display elements is rotated 120 degrees to display a different display face. It is to be understood, of course, that the display elements can have only two faces or four or more display faces. As hereinafter described in detail, each display face can be a surface for painting or gluing the strips of an image to be displayed. More preferably, each of the display elements is capable of supporting a changeable display panel at each of the plurality of faces.

FIG. 2 is an exploded perspective of an example of the major parts of one type of a prismatic display element 14a. This type of display element 14a is a prismatic display element having three planar display surfaces 18a, 18b, and 18c. The display element 14a is rotationally supported by a lower end cap 20 and an upper bushing 22, in a manner well known to those skilled in the art. A strip portion of a printed image to be displayed on the sign may be glued or otherwise secured to one of the display surfaces 18a, 18b, and 18c, in a manner well known to those skilled in the art. Either the display elements 14a must be completely removed and taken to a remote site for applying new images or the new images must be applied to the display elements at the site of the sign.

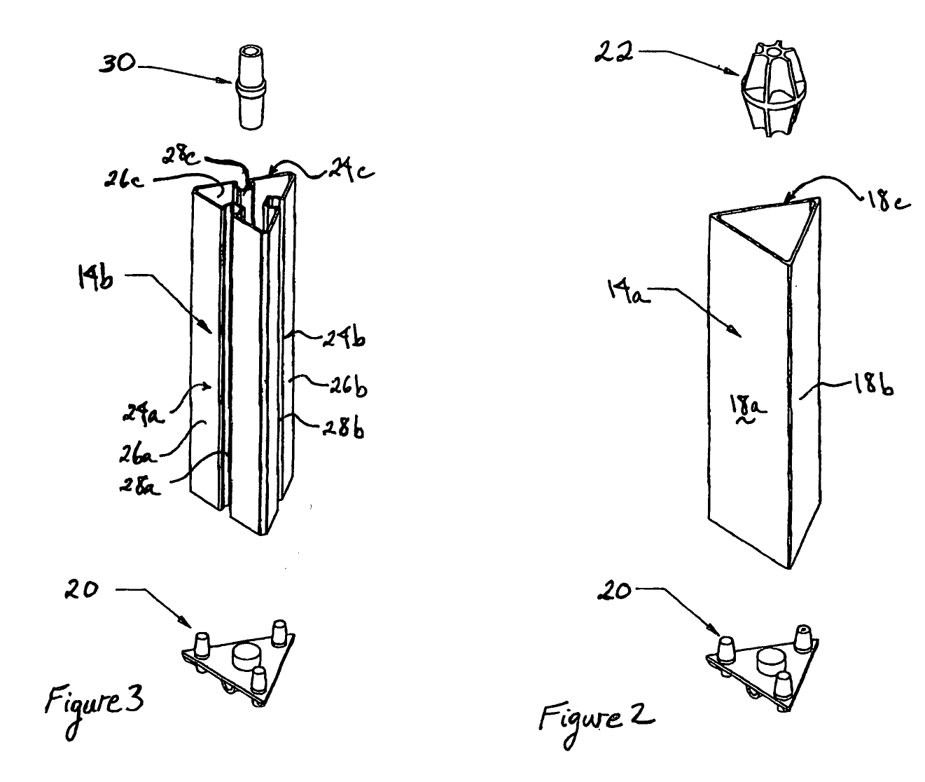

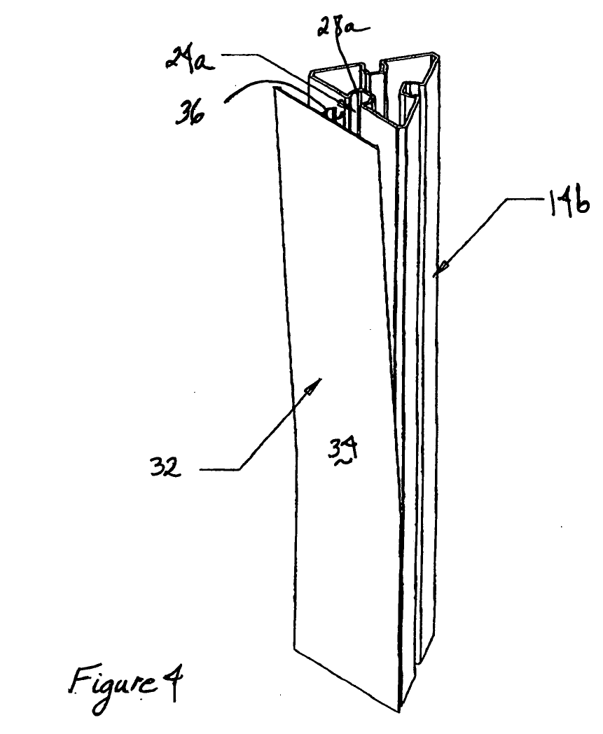

FIG. 3 is an exploded perspective of an example of the major parts of another type of a prismatic display element 14b. This type of display element 14b is generally in the shape of a triangular prism, but, instead of having display surfaces, has three mounting structures 24a, 24b, and 24c adapted for receiving and supporting changeable display panels (not shown in FIG. 3, but which will be described in detail with reference to FIG. 4.) Each of the mounting structures 24a, 24b, and 24c preferably comprises a support backing 26a, 26b, and 26c, respectively, and a snap-in groove 28a, 28b, and 28c, respectively. Continuing to refer now to FIG. 3, the display element 14b is rotationally supported by a lower end cap 20 and an upper bushing 30, in a manner well known to those skilled in the art. FIG. 4 is a perspective view of a display element of the type shown in FIG. 3 illustrating a changeable face panel 32 in the process of being mounted to or removed from one of the mounting structures 24a of the prismatic display element 14b. The changeable face panel 32 provides a display face 34 and has a rib 36 extending longitudinally along its back for engaging the snap-in groove of the mounting structure 24a. This allows the strips of a printed sign image to be remotely applied to the display faces 34 of a plurality of changeable face panels 32, then brought to the site of the sign, a plurality of old changeable display panels to be quickly removed from the prismatic display element 14b of the sign, and then the different plurality of changeable display panels 32 can be quickly and easily snapped into place on the display elements 14b, in a manner well known to those skilled in the art. The changeable face panel 32 preferably is substantially made of rigid PVC plastic.

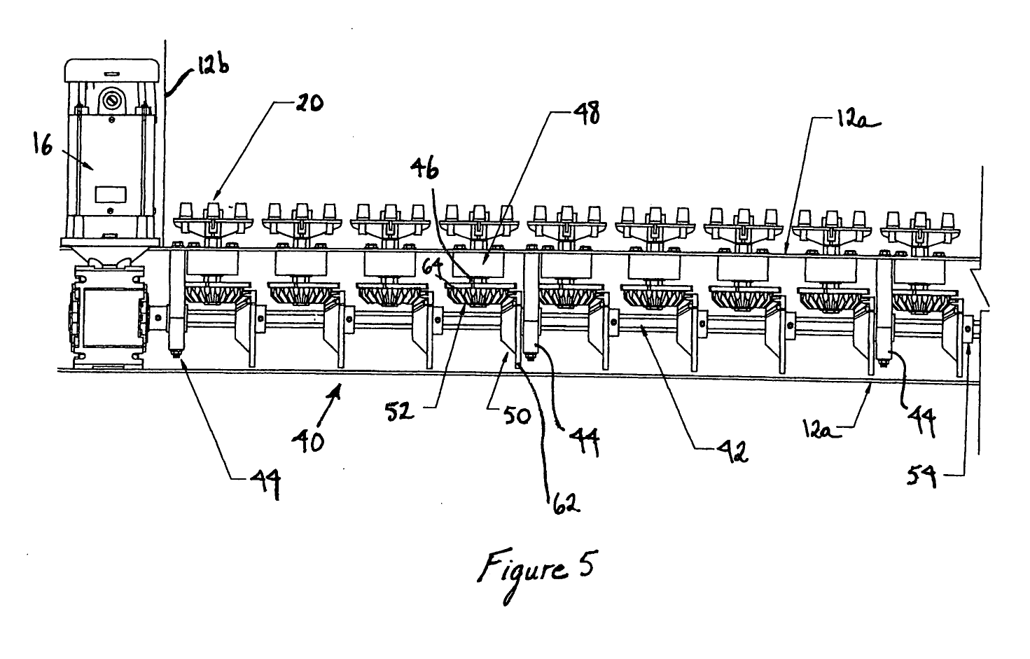

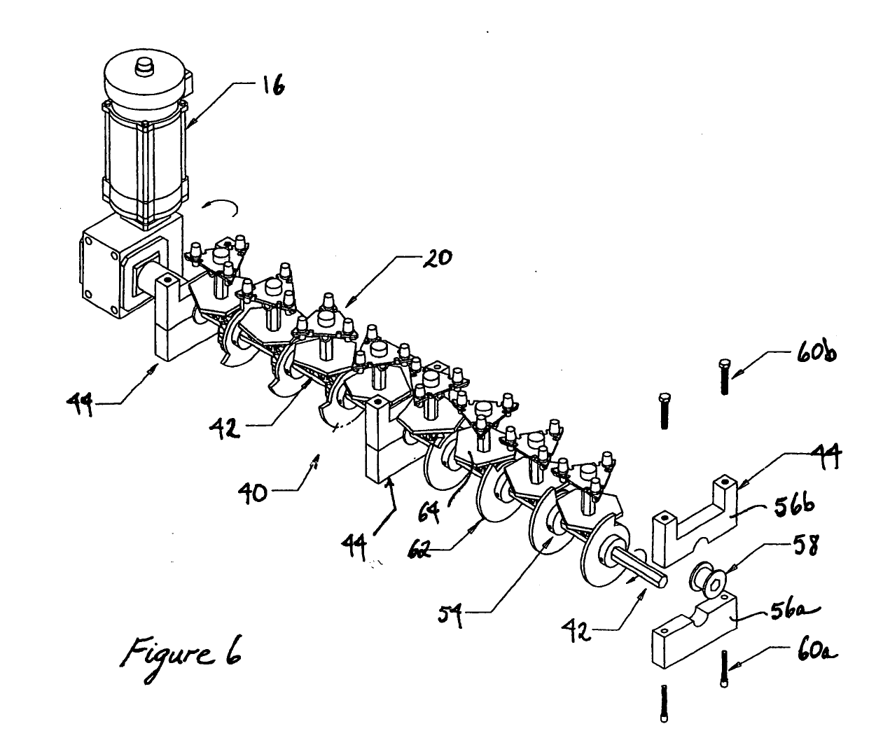

FIG. 5 is a front elevation view of the drive motor 38 and a portion of the drive transmission system 40 for a multi-faced billboard sign. As previously mentioned, the side frame 12b preferably houses the drive motor 16, and the bottom frame 12a preferably houses the drive transmission 40.

The drive transmission system 40 includes a drive shaft 42, which is rotationally supported in the bottom frame 12a by a plurality of pillow block bearings 44, where the drive shaft 42 defines a drive shaft rotational axis. The drive shaft 42 is preferably multi-sided, and most preferably the drive shaft 42 is hexagonal. The drive motor 16 is operatively connected to rotationally drive the drive shaft 42. Preferably, the drive shaft 42 is directly connected to the drive motor 16. Preferably, the drive shaft rotational axis is oriented substantially horizontal to the ground.

The drive transmission system 40 also includes an output shaft 46 operatively associated with each of the display elements 14 (not shown in FIG. 5), preferably through the lower end cap 20 of each of the display elements. Each output shaft 46 is rotationally supported on the frame 12a by a thrust bearing subassembly 48. The output shaft 46 of each of the display elements: (i) is operatively connected to rotate an associated one of the plurality of display elements; (ii) defines an output shaft rotational axis; and (iii) has its output shaft rotational axis in non-parallel relationship to the rotational axis of the drive shaft. Preferably, the output shaft 46 is multi-sided, and most preferably the output shaft 46 is hexagonal. Preferably, the output shaft 46 is directly connected to the display element at the lower end cap 20. Preferably, a projection of the output shaft rotational axis intersects the drive shaft rotational axis. Most preferably, the output shaft rotational axis and the drive shaft rotational axis are perpendicular. Typically, the output shaft rotational axis is also oriented substantially vertical to the ground.

The drive transmission system 40 also includes a plurality of gear subassemblies for transferring rotational motion from the drive shaft 42 and to each of the output shafts 46, which gear subassemblies may be of any convenient design known to those skilled in the art. As will hereinafter be described in more detail, however, according to a first aspect of the invention, a gear subassembly is provided having an alignment element, and other and further aspects of a preferred gear subassembly according to the invention will be described. Each gear subassembly preferably comprises an input gear element 50 and an output gear element 54. Preferably, each input gear element 50 is provided with a locking collar 54 on the drive shaft 42.

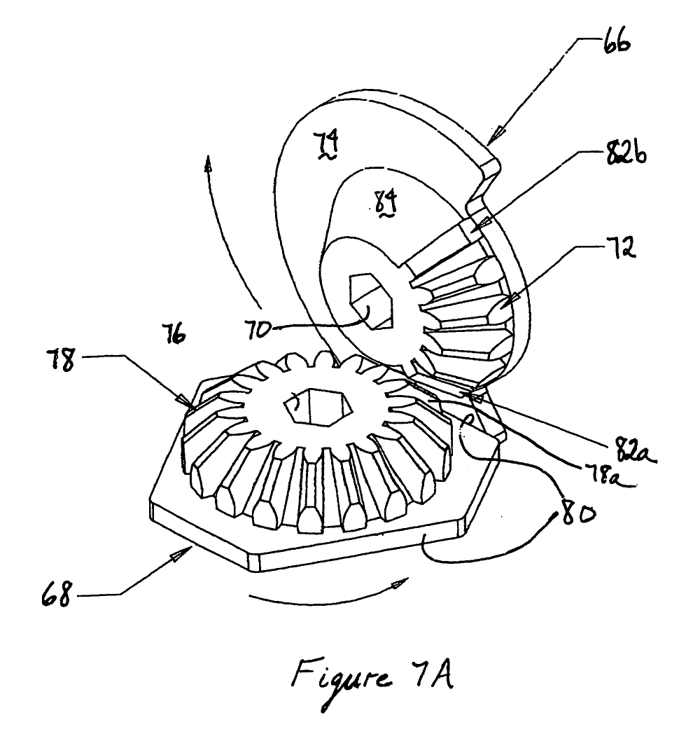

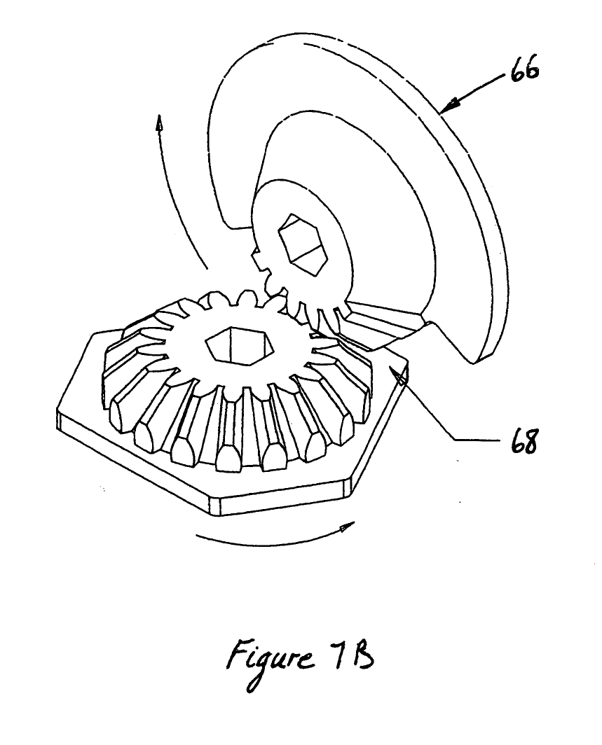

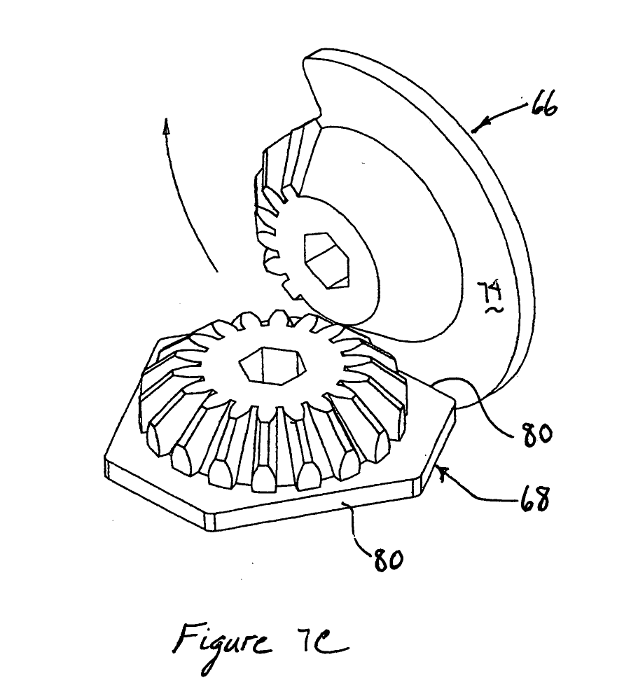

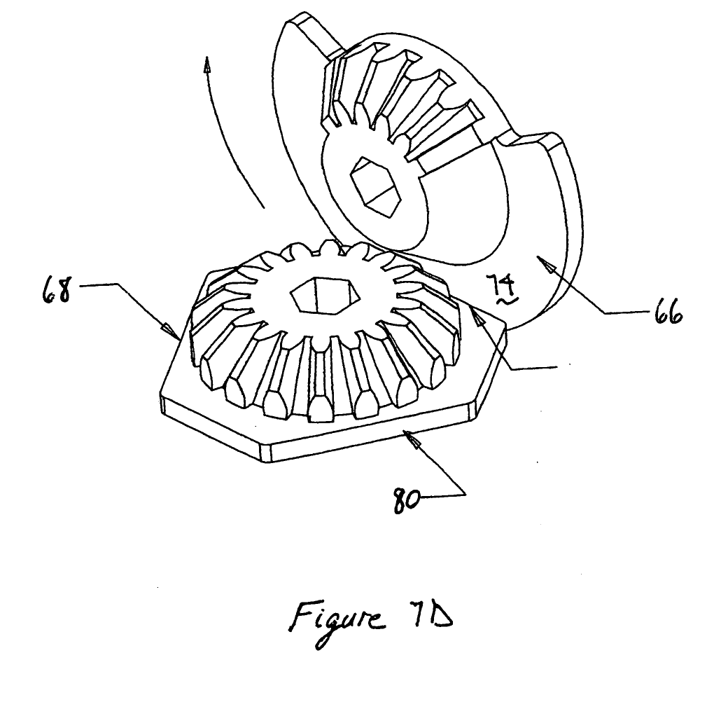

As will be appreciated, FIG. 5 illustrates an embodiment of the invention where all of the gear subassemblies are axially aligned to simultaneously rotate the output shafts 46 for the display elements. Also shown in FIG. 5 is input slip element 62 and output slip element 64, which will be hereinafter discussed in more detail with reference to FIGS. 7A-D.

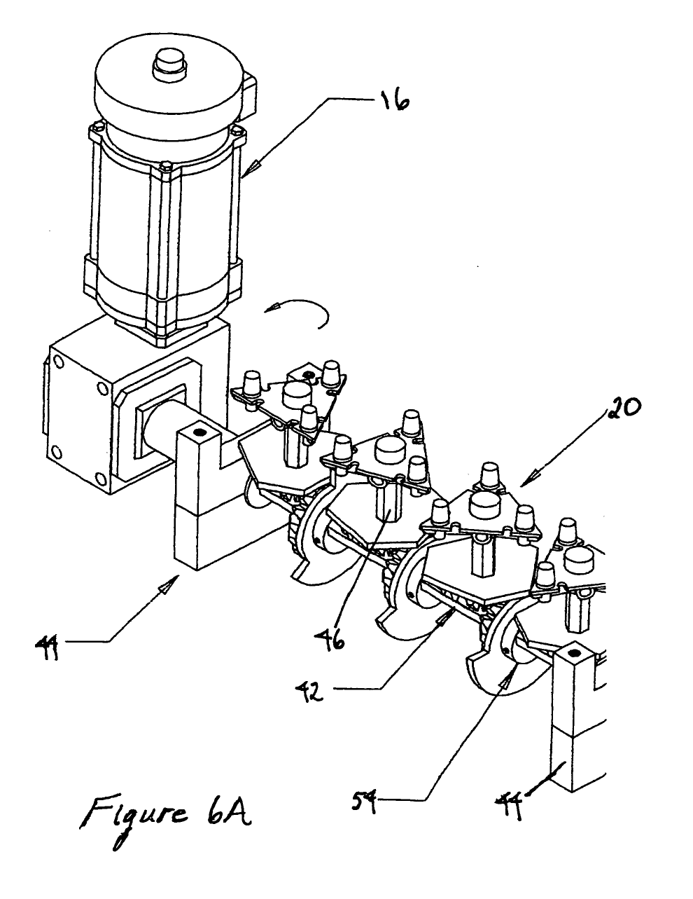

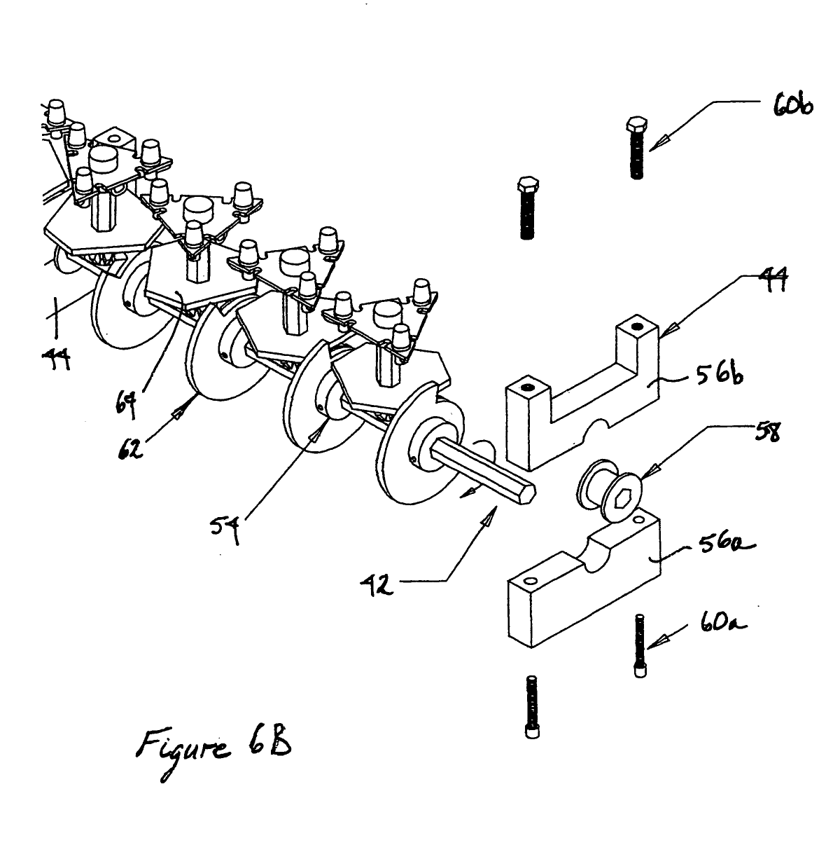

FIG. 6 is a perspective view of the drive motor 16 and the drive transmission system 40 for a multi-faced billboard sign having a plurality of gear subassemblies and slip subassemblies according to the invention, wherein the drive transmission system 40 rotates the prismatic display elements in a wave-like manner. FIG. 6A is an enlarged perspective view of the drive-motor end of the transmission system shown in FIG. 6, and FIG. 6B is an enlarged perspective view of the terminal end of the transmission system shown in FIG. 6. In FIGS. 6 and 6B, the pillow block bearing 44 is shown in exploded view, having a lower housing 56a and an upper housing 56b adapted for holding a drive shaft bearing 58. The lower housing 56a and upper housing 56b are secured together, for example, by a plurality of lower socket head screws 60a and upper hex head screws 60b.

As will be hereinafter explained in detail with respect to FIGS. 7A-D, a sign includes a gear subassembly operatively associated between the drive shaft and the output shaft of one of the display elements. The gear subassembly comprises: (i) an input gear element: (a) operatively connected to be rotated by the drive shaft; (b) defining an input gear element rotational axis; and (c) comprising a plurality of input gear teeth arranged to extend in a first arcuate portion around the input gear element rotational axis and defining a gap in the plurality of input gear teeth that extends in a second arcuate portion around the input gear element rotational axis; and (ii) an output gear element: (a) operatively connected to the output shaft; (b) defining an output gear element rotational axis; and (c) comprising a plurality of output gear teeth arranged to extend circumferentially around the output gear element rotational axis, the output gear teeth adapted to mesh with the input gear teeth of the input gear element; where: (i) during a first portion of a 360 degree rotation of the input gear element, the input gear teeth engage the output gear teeth to transfer rotational motion from the drive shaft to the output shaft; and (ii) during a second portion of a 360 degree rotation of the input gear element, the input gear teeth disengage the output gear teeth to not transfer rotational motion from the drive shaft to the output shaft.

According to the first aspect of the invention, the sign further comprises at least one alignment element for the gear subassembly, where the alignment element: (i) is operatively positioned adjacent an arcuate end of the plurality of input gear teeth; and (ii) comprises a partial gear tooth.

Preferably, the input gear element is directly connected to the drive shaft 42. Preferably, the input gear rotational axis is parallel with the drive shaft rotational axis. Most preferably, the input gear rotational axis is co-axial with the drive shaft rotational axis.

Preferably, the output gear element is directly connected to the output shaft. Preferably, the output gear rotational axis is parallel with the output shaft rotational axis. Most preferably, the output gear rotational axis is co-axial with the output shaft rotational axis.

The gear subassembly is preferably one of a plurality of gear subassemblies, each gear subassembly operatively associated between the drive shaft and one of the plurality of output shafts. Accordingly, a separate gear subassembly is preferably operatively associated between the drive shaft and each one of the plurality of output shafts.

As will be hereinafter explained in detail with respect to FIGS. 7A-D, according to the second aspect of the invention, the sign includes a slip subassembly operatively associated between the drive shaft and the output shaft. The slip subassembly comprises: (i) an input slip element: (a) operatively connected to be rotated by the drive shaft; (b) defining an input slip rotational axis; (c) defining a generally arcuate line that has a radius from the input slip rotational axis at least as large as the radius of the plurality of input gear teeth, that is non-intersecting with the input slip rotational axis, and that extends around a first portion of the input slip rotational axis, and (d) defining a generally arcuate gap along an arcuate line that has a radius from the input slip rotational axis at least as large as the radius of the plurality of input gear teeth, and that extends around a second portion of the input slip rotational axis; and (ii) an output slip element: (a) operatively connected to the output shaft; (b) defining an output slip rotational axis; and (c) defining a generally straight line that has a radial distance from the rotational axis of the output slip hub at least as large as the radius of the plurality of output gear teeth, that is non-intersecting with the input slip rotational axis, and that extends perpendicular to the input rotational axis of the input slip, the straight line adapted to be rotationally positioned into substantially co-planar alignment with the generally arcuate line defined by the input slip element.

During a first portion of a 360 degree axial rotation of the input slip element 62, the arcuate line defined by the input slip element and the straight line defined by the output slip element 64 are in substantially co-planar alignment, and the input and output slip elements are in slipping contact as the input slip element rotates to prevent the output slip element from rotating. During a second portion of a 360 degree rotation of the input slip element 62, the arcuate line defined by the input slip element and the straight line defined by the output slip element 64 are out of co-planar alignment as the input slip element rotates, and the elements are out of slipping contact to allow the output slip element to rotate.

Preferably, the input slip element 62 is directly connected to the drive shaft. Preferably, the input slip rotational axis is parallel with the drive shaft rotational axis. Most preferably, the input slip rotational axis is co-axial with the drive shaft rotational axis.

Preferably, the output slip element 64 is directly connected to the output shaft. Preferably, the output slip rotational axis is parallel with the output shaft rotational axis. Most preferably, the output slip rotational axis is co-axial with the output shaft rotational axis.

The slip subassembly is one of a plurality of slip subassemblies, each slip subassembly operatively associated between the drive shaft 42 and one of the plurality of output shafts 46. Accordingly, most preferably a separate slip subassembly is operatively associated between the drive shaft 42 and each one of the plurality of output shafts 46.

Referring now to FIG. 7A of the drawing, according to the third aspect of the invention, the first and second aspects of the invention are most advantageously employed together. Most preferably, the input gear element 50 of the gear subassembly and the input slip element 62 of the slip subassembly are integrally formed into a single input element 66. Most preferably, the output gear element 52 of the gear subassembly and the output slip element 64 of the slip subassembly are integrally formed into a single output element 68.

The integrally-formed input element 66 preferably comprises an input hub 70, a partial bevel gear having a plurality of input gear teeth 72, and has an arcuate stop 74. Preferably, the input gear hub 70 defines a generally frusto-conical shape. The integrally-formed output element 68 preferably comprises an output hub 76, a bevel gear having a plurality of output gear teeth 78, and a plurality of shoulders 80 to contact the stop 74. Preferably, the output gear hub 76 defines a generally frusto-conical shape.

Preferably, there are four (4) full input gear teeth 72 arranged partially about the input hub 70 of the input element 66.

Preferably, there are also two (2) partial input gear teeth 82a and 82b that are also adapted to mesh with the output gear teeth 78. Preferably, each of the partial gear teeth 82a and 82b has a height that is about one-half the height of the input gear teeth 72. The profile of each of the partial gear teeth 82a and 82b is adapted to assist positive meshing of the gears as a shoulder 80 begins and ends contact with the stop 74. This is to help prevent any premature rotation of the output element 68 before the proper meshing of the gear teeth is made. Without this feature, depending upon external loading of the output gear, the output gear could turn slightly as the stop 74 rotates away from the shoulder 80, causing the gears to be out of timing or alignment. This would result in a mechanical lock of the drive unit. The partial gear tooth 82a is designed to clear the emerging output gear tooth 78a of the output gear and provide positive alignment for proper engagement of the remaining teeth before the stop 74 and shoulder 80 disengage.

Together, the input gear teeth 72 and the partial input gear teeth 82a and 82b are arranged to extend about 120 degrees around the hub 70 of the input element 66. If the partial input gear teeth are not used, the input gear teeth 72 are preferably extended to about 120 degrees around the input hub 70. Thus, the input gear teeth 72 are adapted to engage the output gear teeth 78 and rotate the output element 68 about 120 degrees. A gap 84 in the input gear teeth 72 extends in an arc about 240 degrees around the rotational axis of the input gear.

Most preferably, the input element 66 is symmetrical about a plane that includes the input rotational axis. Thus, the gears can mesh and be rotated in either direction. For example, preferably the input gear teeth 72 and the output gear teeth 78 are beveled. Most preferably, the input gear teeth 72 and the output gear teeth 78 are straight-toothed. Most preferably, the input gear teeth 72 and the output gear teeth 78 have a 1:1 ratio. Preferably, the input gear teeth and the output gear teeth are adapted for meshing in either direction. Furthermore, partial input gear teeth 82a and 82b are most preferably symmetrically located on either side of the input gear teeth 72 to enable the drive shaft to operate the gear in forward and reverse (or clockwise and counter-clockwise) directions. By rotating the input gear element one revolution, the output gear will rotate 120 degrees. One rotation of the input gear will provide one face change of the louver, which is a triangular element.

As illustrated in FIG. 5, the input gear can be installed to be aligned on the drive shaft 42 to provide simultaneous rotation of all the display elements, which are attached to the output elements with an output shaft 46. With this arrangement, all the display elements will rotate together. If the input gears are installed on a hex shaft with a 70-degree twist in alignment from end to end, as illustrated in FIG. 6, the display elements will be rotated in a domino or “wave” pattern. The direction of the wave can be controlled by a twist in the shaft (clockwise or counterclockwise).

FIG. 7A is a perspective view of the integrally-formed input and output gear alignment and slip structures 66 and 68 according to the presently most-preferred embodiment of the invention, where the input gear teeth are rotating into engagement with the output gear teeth.

FIG. 7B is a perspective view of the integrally-formed gear alignment and slip structures 66 and 68 according to the presently most-preferred embodiment of the invention, where the input gear teeth are engaged with the output gear teeth to rotate the output gear element.

FIG. 7C is a perspective view of the integrally-formed gear alignment and slip structures 66 and 68 according to the presently most-preferred embodiment of the invention, where (i) the input gear teeth are rotating out of engagement with the output gear teeth, and (ii) an arcuate surface of the input slip flange of the input slip element and a slip face of the output slip flange are rotated into slipping engagement that prevents the rotation of the output shaft.

FIG. 7D is a perspective view of the integrally-formed gear alignment and slip structures 66 and 68 according to the presently most-preferred embodiment of the invention, where (i) the input gear teeth are rotating out of engagement with the output gear teeth, and (ii) an arcuate surface of the input slip flange of the input slip element and a slip face of the output slip flange are rotated into slipping engagement that prevents the rotation of the output shaft.

As will be appreciated from the FIGS. 7A-D, the interaction between the input element and the output element need not be with a stop 74 defining an arcuate surface. For example, as will be appreciated by those skilled in the art, a chord of an arcuate line defined by the input slip element is the generatrix defining an arcuate plane as the input slip element rotates. Of course, the arcuate line defined by the input slip element can be part of a generally arcuate surface. The arcuate line defined by the input slip element preferably extends about 240 degrees around the input slip rotational axis. The arcuate line defined by the input slip element is located adjacent the gap 84 in the plurality of input gear teeth 72. The arcuate gap defined by the input slip element extends about 120 degrees around the input slip rotational axis. The arcuate gap defined by the input slip element is located adjacent the input gear teeth 72. The input slip element is most preferably symmetrical about a plane that includes the input slip rotational axis.

As will also be appreciated, a straight line defined by the output slip element can be part of an edge. And the edge can be part of a planar surface, such as a shoulder 80. The straight line defined by the output slip element is one of a plurality of straight lines, each straight line being non-intersecting with and extending perpendicular to the input rotational axis of the input slip, and each straight line adapted to be rotationally positioned into substantially co-planar alignment with the generally arcuate line defined by the input slip element. Preferably, the plurality of straight lines defined by the output slip element is three straight lines. The plurality of straight lines defined by the output slip element are preferably at 120 degrees relative to one another and generally define a triangular shape. Most preferably, the output slip element is generally hexagonal in a plane that is perpendicular to the output slip rotational axis, and the plurality of straight lines define three of the six sides of the hexagonal shape. The straight line defined by the output slip element, when rotationally positioned into co-planar alignment with the arcuate line defined by the output slip element, is a chord on the arcuate line.

Preferably, the gear subassembly is substantially made of engineering grade plastic. Similarly, the slip subassembly preferably is also substantially made of engineering grade plastic.

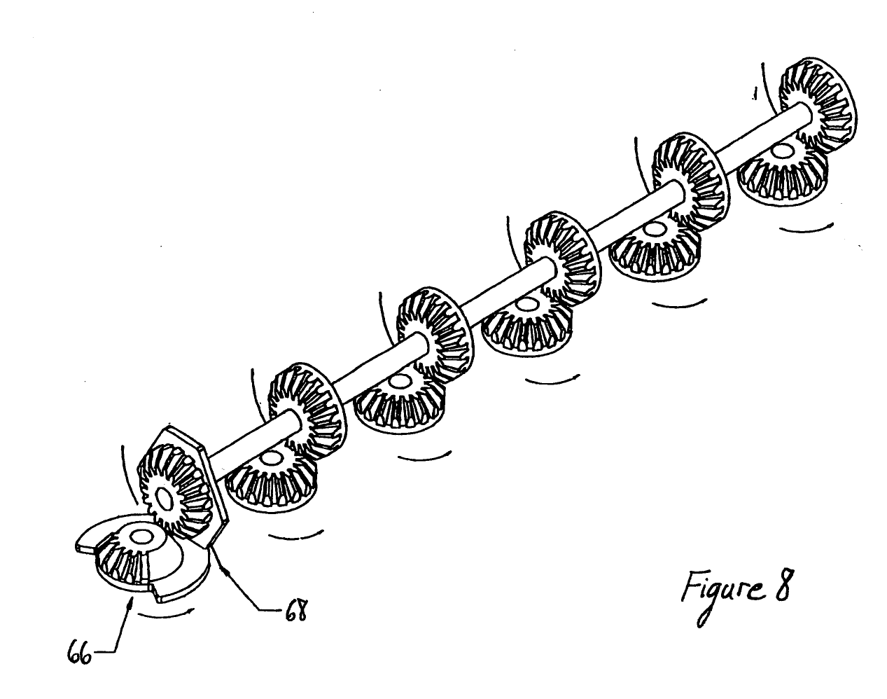

FIG. 8 is a perspective view of an alternative embodiment according to the present invention, modified as will be understood by those skilled in the art, where a single, integrally-formed gear subassembly with alignment teeth and slip subassembly, which comprise an input element 66 and an output element 68, are illustrated in an arrangement that can be used to index a drive transmission system for a multi-faced sign.

The invention is described with respect to presently-preferred embodiments, but is not intended to be limited to the described embodiments. It will be readily apparent to those of ordinary skill in the art that numerous modifications may be made to the invention without departing from the scope and spirit of the invention as defined by the claims.

1-3. (canceled)

4. A transfer assembly for periodically rotating a plurality of display elements of a multi-faced sign, the sign having a drive shaft and a plurality of output shafts, each output shaft operatively associated with one of the display elements, the transfer assembly comprising:
(A) a gear subassembly operatively associated between the drive shaft and the output shaft of one of the display elements, where the gear subassembly comprises:
(i) an input gear element operatively connected to be rotated by the drive shaft, the input gear element comprising an input gear hub, a plurality of input gear teeth arranged to extend partially around the input gear hub, and a toothless gap extending partially around the input gear hub; and
(ii) an output gear element operatively connected to the output shaft, the output gear comprising an output gear hub and a plurality of output gear teeth arranged to extend circumferentially around the output gear hub, the output gear teeth adapted to mesh with the input gear teeth of the input gear element;
where:
(i) during a first portion of a 360 degree rotation of the input gear element, the input gear teeth engage the output gear teeth to transfer rotational motion from the drive shaft to the output shaft; and
(ii) during a second portion of a 360 degree rotation of the input gear element, the input gear teeth disengage the output gear teeth, and the toothless gap does not transfer rotational motion from the drive shaft to the output shaft; and
(B) a slip subassembly operatively associated between the drive shaft and the output shaft, where the slip subassembly comprises:
(i) an input slip element operatively connected to be rotated by the drive shaft, the input slip element comprising an input slip hub and an input slip flange, the input slip flange defining a generally arcuate surface that has an inner radius from the rotational axis of the input slip hub at least as large as the radius of the plurality of input gear teeth, that is non-intersecting with the rotational axis of the input slip hub, and that extends around a first portion of the input slip hub, and defining a generally arcuate gap along an arcuate line that has a radius from the rotational axis of the input slip hub at least as large as the radius of the plurality of input gear teeth, and that extends around a second portion of the input slip hub;
(ii) an output slip element operatively connected to the output shaft, the output slip element comprising an output slip hub and an output slip flange, the output slip flange defining a generally straight edge that has a radial distance from the rotational axis of the output slip hub at least as large as the radius of the plurality of output gear teeth, that is non-intersecting with the rotational axis of the input slip hub, and that extends perpendicular to the rotational axis of the output slip hub, the straight edge adapted to be rotationally positioned into substantially co-planar alignment with the generally arcuate surface defined by the input slip flange;
where:
(i) during a first portion of a 360 degree axial rotation of the input slip element, the arcuate surface defined by the input slip flange and the straight edge defined by the output slip flange are in substantially co-planar alignment, and the input and output slip elements are in slipping contact as the input slip element rotates to prevent the output slip element from rotating;
(ii) during a second portion of a 360 degree rotation of the input slip element, the arcuate surface defined by the input slip flange and the straight edge defined by the output slip flange are out of co-planar alignment as the input slip element rotates, and the elements are out of slipping contact to allow the output slip element to rotate.

5. A transfer assembly according to claim 4, wherein the straight edge defined by the output slip flange is part of a surface defined by the output slip flange that is non-intersecting with and extends perpendicular to the input rotational axis of the input slip.

6-15. (canceled)

16. A transfer assembly for periodically rotating a plurality of display elements of a multi-faced sign, the sign having a drive shaft and a plurality of output shafts, each output shaft operatively associated with one of the display elements, the transfer assembly comprising:
(A) a gear subassembly operatively associated between the drive shaft and the output shaft of one of the display elements, where the gear subassembly comprises
(i) an input gear element: (a) operatively connected to be rotated by the drive shaft; (b) defining an input gear element rotational axis; and (c) comprising a plurality of input gear teeth arranged to extend in a first arcuate portion around the input gear element rotational axis and defining a gap in, the plurality of input gear teeth that extends in a second arcuate portion around the input gear element rotational axis; and
(ii) an output gear element: (a) operatively connected to the output shaft; (b) defining an output gear element rotational axis; and (c) comprising a plurality of output gear teeth arranged to extend circumferentially around the output gear element rotational axis, the output gear teeth adapted to mesh with the input gear teeth of the input gear element;
where:
(i) during a first portion of a 360 degree rotation of the input gear element, the input gear teeth engage the output gear teeth to transfer rotational motion from the drive shaft to the output shaft; and
(ii) during a second portion of a 360 degree rotation of the input gear element, the input gear teeth disengage the output gear teeth to not transfer rotational motion from the drive shaft to the output shaft;
(B) a slip subassembly operatively associated between the drive shaft and the output shaft, where the slip subassembly comprises:
(i) an input slip element: (a) operatively connected to be rotated by the drive shaft; (b) defining an input slip rotational axis; (c) defining a generally arcuate line that has a radius from the input slip rotational axis at least as large as the radius of the plurality of input gear teeth, that is non-intersecting with the input slip rotational axis, and that extends around a first portion of the input slip rotational axis, and (d) defining a generally arcuate gap along an arcuate line that has a radius from the input slip rotational axis at least as large as the radius of the plurality of input gear teeth, and that extends around a second portion of the input slip rotational axis;
(ii) an output slip element: (a) operatively connected to the output shaft; (b) defining an output slip rotational axis; and (c) defining a generally straight line that has a radial distance from the rotational axis of the output slip hub at least as large as the radius of the plurality of output gear teeth, that is non-intersecting with the input slip rotational axis, and that extends perpendicular to the input rotational axis of the input slip, the straight line adapted to be rotationally positioned into substantially co-planar alignment with the generally arcuate line defined by the input slip element;
where:
(i) during a first portion of a 360 degree axial rotation of the input slip element, the arcuate line defined by the input slip element and the straight line defined by the output slip element are in substantially co-planar alignment, and the input and output slip elements are in slipping contact as the input slip element rotates to prevent the output slip element from rotating;
(ii) during a second portion of a 360 degree rotation of the input slip element, the arcuate line defined by the input slip element and the straight line defined by the output slip element are out of co-planar alignment as the input slip element rotates, and the elements are out of slipping contact to allow the output slip element to rotate.

17-20. (canceled)

21. Original) A multi-faced sign assembly comprising:
(A) a frame;
(B) a drive shaft rotationally supported by the frame, where the drive shaft defines a drive shaft rotational axis;
(C) a drive motor operatively connected to rotationally drive the drive shaft;
(D) a plurality of display elements supported by the frame in a row, where each of the display elements:
(i) defines a plurality of display faces; and
(ii) is rotationally supported adjacent another one of the display elements;
where the plurality of display elements can be selectively rotated to align one display face of each of the display elements in a co-planar relationship to form a substantially planar display, whereby the plurality of display elements can selectively display one of a plurality of displays;
(E) an output shaft operatively associated with each of the display elements, where the output shaft of each of the display elements:
(i) is operatively connected to rotate an associated one of the plurality of display elements;
(ii) defines an output shaft rotational axis;
(iii) has its output shaft rotational axis in non-parallel relationship to the rotational axis of the drive shaft;
(F) a gear subassembly operatively associated between the drive shaft and the output shaft of one of the display elements, where the gear subassembly comprises:
(i) an input gear element: (a) operatively connected to be rotated by the drive shaft; (b) defining an input gear element rotational axis; and (c) comprising a plurality of input gear teeth arranged to extend in a first arcuate portion around the input gear element rotational axis, and defining a gap in the plurality of input gear teeth that extends in a second arcuate portion around the input gear element rotational axis; and
(ii) an output gear element: (a) operatively connected to the output shaft; (b) defining an output gear element rotational axis; (c) comprising a plurality of output gear teeth arranged to extend circumferentially around the output gear element rotational axis, the output gear teeth adapted to mesh with the input gear teeth of the input gear element;
where:
(i) during a first portion of a 360 degree rotation of the input gear element, the input gear teeth engage the output gear teeth to transfer rotational motion from the drive shaft to the output shaft; and
(ii) during a second portion of a 360 degree rotation of the input gear element, the input gear teeth disengage the output gear teeth to not transfer rotational motion from the drive shaft to the output shaft;
(G) at least one alignment element for the gear subassembly, where the alignment element:
(i) is operatively positioned adjacent an arcuate end of the plurality of input gear teeth; and
(ii) comprises a partial gear tooth;
(H) a slip subassembly operatively associated between the drive shaft and the output shaft, where the slip subassembly comprises:
(i) an input slip element: (a) operatively connected to be rotated by the drive shaft; (b) defining an input slip rotational axis; (c) defining a generally arcuate line that has a radius from the input slip rotational axis at least as large as the radius of the plurality of input gear teeth, that is non-intersecting with the input slip rotational axis, and that extends around a first portion of the input slip rotational axis, and (d) defining a generally arcuate gap along an arcuate line that has a radius from the input slip rotational axis at least as large as the radius of the plurality of input tear teeth, and that extends around a second portion of the input slip rotational axis;
(ii) an output slip element: (a) operatively connected to the output shaft; (b) defining an output slip rotational axis; and (c) defining a generally straight line that has a radial distance from the rotational axis of the output slip hub at least as large as the radius of the plurality of output gear teeth, that is non-intersecting with the input slip rotational axis, and that extends perpendicular to the input rotational axis of the input slip, the straight line adapted to be rotationally positioned into substantially co-planar alignment with the generally arcuate line defined by the input slip element;
where:
(i) during a first portion of a 360 degree axial rotation of the input slip element, the arcuate line defined by the input slip element and the straight line defined by the output slip element are in substantially co-planar alignment, and the input and output slip elements are in slipping contact as the input slip element rotates to prevent the output slip element from rotating;
(ii) during a second portion of a 360 degree rotation of the input slip element, the arcuate line defined by the input slip element and the straight line defined by the output slip element are out of co-planar alignment as the input slip element rotates, and the elements are out of slipping contact to allow the output slip element to rotate.

22-23. (canceled)

24. An assembly according to claim 21, wherein each of the display elements is a generally triangular prism with three display faces.

25. An assembly according to claim 24, wherein each of the display elements is rotated 120 degrees to display a different display face.

26. An assembly according to claim 21, wherein each of the display elements is capable of supporting a removable slat at each of the plurality of faces.

27. An assembly according to claim 21, wherein each of the display elements has changeable slats.

28-40. (canceled)

41. An assembly according to claim 21, wherein the gear subassembly is one of a plurality of gear subassemblies, each gear subassembly operatively associated between the drive shaft and one of the plurality of output shafts.

42. An assembly according to claim 21, wherein a separate gear subassembly is operatively associated between the drive shaft and each one of the plurality of output shafts.

43-49. (canceled)

50. An assembly according to claim 21, wherein the input gear teeth and the output gear teeth are adapted for meshing in either direction.

51. (canceled)

52. An assembly according to claim 21, wherein the partial gear tooth has a height that is about one-half the height of the input gear teeth.

53. An assembly according to claim 21, further comprising a second partial gear tooth located at the opposed arcuate end of the plurality of input gear teeth.

54. An assembly according to claim 53, wherein the second partial gear tooth has a height that is about one-half the height of the input gear teeth.

55-61. (canceled)

62. An assembly according to claim 21, wherein the slip subassembly is one of a plurality of slip subassemblies, each slip subassembly operatively associated between the drive shaft and one of the plurality of output shafts.

63. An assembly according to claim 21, wherein a separate slip subassembly is operatively associated between the drive shaft and each one of the plurality of output shafts.

64-78. (canceled)

79. An assembly according to claim 21, wherein the gear subassembly is substantially made of engineering grade plastic.

80. An assembly according to claim 21, wherein the slip subassembly is substantially made of engineering grade plastic.

81. An assembly according to claim 21, further comprising a means for allowing rotation of the drive shaft and output shaft in either rotational direction.

82. An assembly according to claim 81, wherein the means for allowing rotation of the drive shaft and output shaft in either rotational direction comprises an input gear element that is symmetrical about a plane that includes the input gear rotational axis.

83. An assembly according to claim 82, wherein the means for allowing rotation of the drive shaft and output shaft in either rotational direction further comprises an input slip element that is symmetrical about a plane that includes the input slip rotational axis.
